(19) United States
(12) Patent Application Publication
(10) Pub. No.: US 2014/0081656 A1
(43) Pub. Date: Mar. 20, 2014

(54) AUTOMATED DENTAL EXAM AND CONSULTATION SYSTEM, METHOD, AND COMPUTER PROGRAM PRODUCT

(71) Applicant: Faten Saeed ALAMRI, Riyadh (SA)

(72) Inventor: Faten Saeed ALAMRI, Riyadh (SA)

(21) Appl. No.: 13/616,361

(22) Filed: Sep. 14, 2012

(51) Int. Cl. G06Q 50/24

(52) U.S. Cl. 705/3

(57) ABSTRACT

An automated dental exam and consultation system includes a patient reception unit configured to receive patient information, an examination unit that includes a plurality of medical supplies and configured to perform a desired dental examination, based on the patient information, on the patient, a consulting unit configured to analyze the results of the desired dental examination, recommend another desired dental exam based on the analysis of the examination results, and store the desired dental examination results onto a dental exam database, and a maintenance unit configured to perform a diagnostic analysis of the examination unit, generate a refill signal if one of the plurality of medical supplies falls below a predetermined threshold, generate a service request if a component of the examination unit needs repair, and sterilize the contents of examination unit.

### BACKGROUND

GRANT OF NON-EXCLUSIVE RIGHT

This application was prepared with financial support from the Saudi Arabian Cultural Mission, and in consideration therefore the present inventor has granted The Kingdom of Saudi Arabia a non-exclusive right to practice the present invention.

### FIELD OF THE DISCLOSURE

Embodiments described herein relate generally to a system, method, and computer programming product for performing an automated dental examination. More particularly, the embodiments described herein relate to an autonomous system and method for performing an automated dental exam on an identified patient, processing the results of the examination, and then performing various follow-up functions based on the results of the examination.

### SUMMARY

According to an embodiment, an automated dental exam and consultation system includes a patient reception unit configured to receive patient information, an examination unit that includes a plurality of medical supplies and configured to perform a desired dental examination, based on the patient information, on the patient, a consulting unit configured to analyze the results of the desired dental examination, optionally recommend another desired dental exam based on the analysis of the examination results, and store the desired dental examination results onto a dental exam database, and a maintenance unit configured to perform a diagnostic analysis of the examination unit, generate a refill signal if one of the plurality of medical supplies falls below a predetermined threshold, generate a service request if a component of the examination unit needs repair, and sterilize the contents of examination unit.

According to another embodiment, a method of an automated dental exam and consultation system includes the steps of receiving, using a patient reception unit, patient information from a patient, performing, using a examination unit, a desired dental examination on the patient based on the received patient information and generate examination results, analyzing, using a consulting unit, the examination results and recommending an additional desired dental examination based on the analysis, and storing the examination results into a dental exam database.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the present advancements and many of the attendant advantages thereof will be readily obtained as the same becomes better understood by reference to the following detailed description when considered in connection with the accompanying drawings. However, the accompanying drawings and the exemplary depictions do not in any way limit the scope of the advancements embraced by the specification. The scope of the advancements embraced by the specification and drawings are defined by the words of the accompanying claims.

FIG. 1 is a functional block diagram of an automated dental exam and consultation system according to an exemplary embodiment.

FIG. 2 is a sequence diagram of a patient examination using the automated dental exam and consultation system according to an exemplary embodiment.

FIG. 3 is a is a sequence diagram of a maintenance cycle of the automated dental exam and consultation system according to an exemplary embodiment.

FIG. 4 is a hardware block diagram of an automated dental exam and consultation system according to an exemplary embodiment.

### DETAILED DESCRIPTION OF THE EMBODIMENTS

In order to maintain their dental health, periodic dental visits have been recommended in order to detect, identify, and correct dental issues before they become a serious problem. Unfortunately, because of the limited hours and availability of traditional dentist offices, people are wasting time periodically contacting various dentist offices in order to schedule a checkup visit and they typically have to miss school, work, and/or business appointments to attend these checkup visits. Check up visits typically include fairly simple activities such as visual inspections and obtaining dental imagery such as X-rays. These checkup visits can also be expensive due to the overhead required to staff and operate a dental clinic.

The inventor recognized the need to save patient time as well as the time of dental clinic workers, with the use of the advanced technology available today. The proposed invention is based on having a smart dental clinic that operates without a full medical crew and optionally is unstaffed. It can perform a variety of functions that are performed in a routine dental exam such as taking basic X-ray with an X-ray machine as well as obtaining photographs with a digital camera to provide a real picture of the inside of the patient's mouth. The smart clinic can work though either an autonomous robot or machine, or with a operator at a remote location that has full access to direct and control the robot or machine.

The numerous advantages of the proposed invention include a 24 hour availability for a dental exam which provides significant convenience to a patient. All exams and records are process and sent to a remote facility for examination and storage. The smart clinic is also capable of extended use through periodic maintenance and sterilization of the dental exam equipment to ensure a high degree of quality and sanitation is placed in every exam. The smart clinic can also be accessed through the internet for the purposes of scheduling and exam results by patients.

Referring now to the drawings, wherein like reference numerals designate identical or corresponding parts throughout several views.

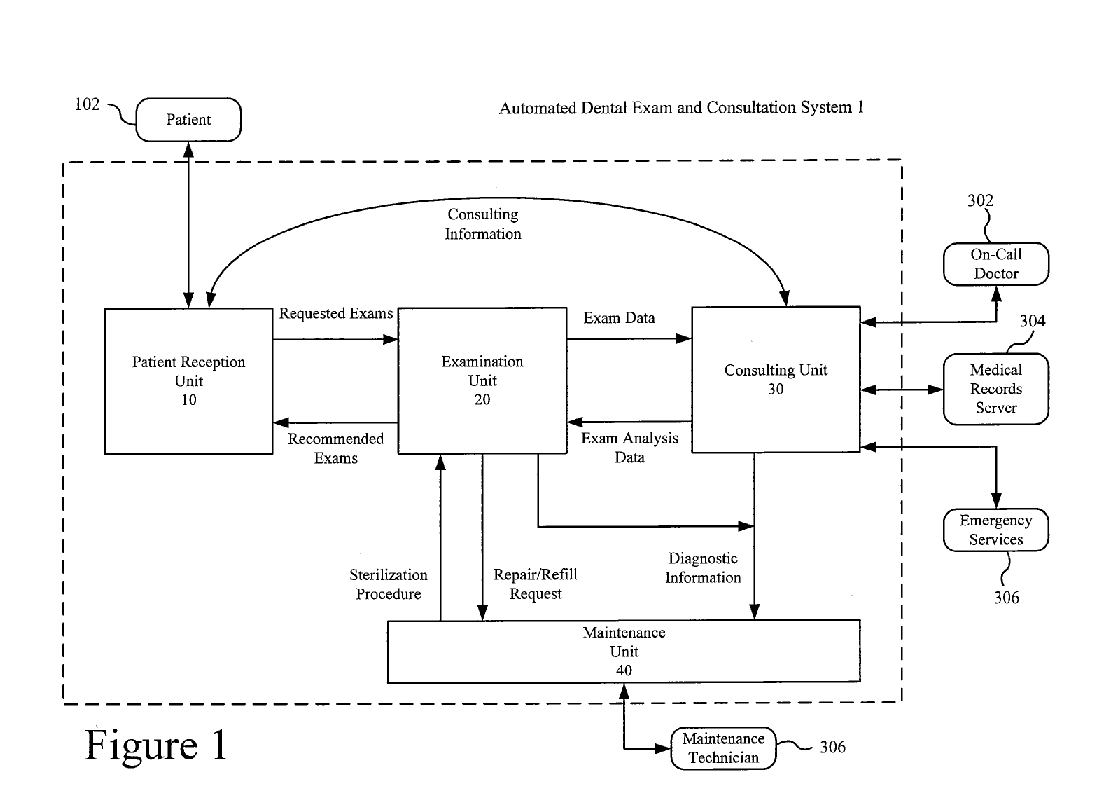

FIG. 1 is a functional block diagram of an automated dental exam and consultation system 1 according to an exemplary embodiment. The automated dental exam and consultation system 1 includes a patient reception unit 10, an examination unit 20, a consulting unit 30, and a maintenance unit 40. The automated dental exam and consultation system 1 also communicates with external users, such as a patient 102, an on-call doctor 302, emergency services 306, and a maintenance technician 306, either directly or remotely via a wired or wireless network such as the internet. The automated dental exam and consultation system 1 also stores medical records and exam results on a local storage device or a remote storage medium such as a medical records server 304. The medical records server 304 can be accessed at any time by the patient 102, the patients normal doctor (not shown), or the on-call doctor 302 via a secure login procedure.

The patient reception unit 10 provides the main interface between the patient 102 and the automated dental exam and consultation system 1. The patient 102 can access the patient reception unit 10 at any time in order to schedule an appointment or request services. Scheduling an appointment can be accomplished through an electronic or online scheduling system to allow the patient 10 to easily schedule an appointment or request services at their convenience. When requesting services, the patient 10 will enter the desired services such as a basic exam or performing X-rays of a particular part of the jaw. The patient 10 can also input health insurance and payment information into the patient reception unit in order to pay for the services received. One the services of the automated dental exam and consultation system 1 have been received, the patient reception unit will also provide, either through electronic copy or hard copy, a bill as well as the results of the exam for the patients 10 records.

The examination unit 20 provides the physical capability of performing the desired dental exam of the patient 102. The examination unit 20 receives the desired exams from the patient reception unit 10 once they have been entered by the patient 102. The examination unit 20 will perform an initialization procedure, if necessary, based on the type of examination to be performed on the patient 102. The examination unit 20, all or in part, can be autonomous in nature or be controlled remotely by an operator and use standard and specialized medical supplies to facilitate the autonomous features.

In a non-limiting example of the examination unit 20, when a patient 102 requests that an exam be performed to investigate a sensitive tooth, the examination unit 20 will provide a mouthpiece for the patient to bite onto or place inside of their mouth. Once the mouthpiece is determined to be in position, the examination unit will obtain imagery of the sensitive area. Once the imagery has been obtained, the examination unit 20 will indicate to the patient 102 to remove the mouthpiece. The examination unit 20 may also provide a specialized helmet or mouthpiece that poses or orientates the patient 102 head in order to properly obtain X-ray images for a deeper look into the sensitive tooth.

Once the examination is complete, exam data from the examination unit 20 is sent to the consulting unit 30 for processing. The consulting unit 30 can be configured to generate a variety of diagnostic results for immediate feedback to the patient 102. Diagnostic results can be generated from a list of known ailments with corresponding symptoms or can be generated from similar results from previous patients that have been diagnosed though other methods such as from the on-call doctor 302.

In a non limiting example, if a patient 102 is exhibiting significant tooth discomfort as well slight discoloration in a part of the tooth seen from imagery obtained from the examination unit 20, the consulting unit 30 will attempt to diagnose the issue based on a dictionary of known dental ailments and their corresponding symptoms. The consulting unit 30 can also attempt to diagnose the ailment based on similar results from previous patients that have previously been diagnosed by the on-call doctor 302. The latter method essentially allows the automated dental exam and consultation system 1 to become smarter about diagnosing patient 102 ailments over time. These diagnostic methods can also be used in conjunction with each other or additional diagnostic methods so as to affirm or increase the probability of a correct diagnosis.

The consulting unit 30 can also recommend additional exams to be completed by the examination unit 20. If the automated dental exam and consultation system 1 determined that additional information was needed to make a correct diagnosis, a recommendation could be made to the patient 102 to perform additional tests. Continuing the previous example, based on the results of the tooth discomfort and the slight discoloration, the consulting unit 30 may initially diagnose that the patient 102 has a cavity, but only with a certain probability. The consulting unit 30 would then recommend that an X-ray be obtained for a closer look at the painful tooth. Once the examination unit 20 obtains X-rays of the patient 102 and send the X-ray data to the consulting unit 30, the consulting unit 30 would then increase the probability that the correct diagnosis is in fact a cavity in light of the additional test results.

If the consulting unit 30 is unable to process the exam data received by the examination unit 20, generate diagnostic information to a sufficient probability, or if a priority or severe condition (such as severe pain or bleeding) is detected during the examination, the consulting unit will contact the on-call doctor 302. The on-call doctor 302 can be in a local or remote facility and can be contact via any method such a visual, voice, or text communication. The on-call doctors can interact with either the consulting unit 30 or directly with the patient 102 via the patient reception unit 10.

After the examination is complete, the consulting unit 30 stores the examination results and diagnostic results into the medical records server 304. If at any time during the examination process, a life threatening situation for the patient 102 of any kind is been detected by either the consulting unit 30 or the on-call doctor 302, emergency services 306 is alerted.

When the patient exits the automated dental exam and consultation system 1, the maintenance unit prepares the automated dental exam and consultation system 1 for the next patient or troubleshoots any issues arising from a particular component. As a routine procedure, the maintenance unit 40 sterilizes all of the equipment used by the examination unit 20. The sterilization can be accomplished through steam sterilization, chemical sterilization, or the such. This process helps maintain a sanitary condition within the automated dental exam and consultation system 1 and reduces the spread of germs. The maintenance unit also verifies the inventory of medical supplies and liquids used during the examination process such as cotton swabs or mouthwash. When the supply level of any particular medical item drops below a predetermined threshold, the maintenance technician 402 is notified to correct the issue. The maintenance unit 40 will also perform a system or component diagnosis during periodic intervals to determine the health of each component within the system or the system as a whole. The maintenance technician 402 is also notified to correct component or system issues arising from the periodic diagnosis. If the maintenance unit 40 detects a serious issue that prevents the automated dental exam and consultation system 1 from operating at a full capacity, the maintenance unit will shut down the automated dental exam and consultation system 1 until the failure is corrected by the maintenance technician 402.

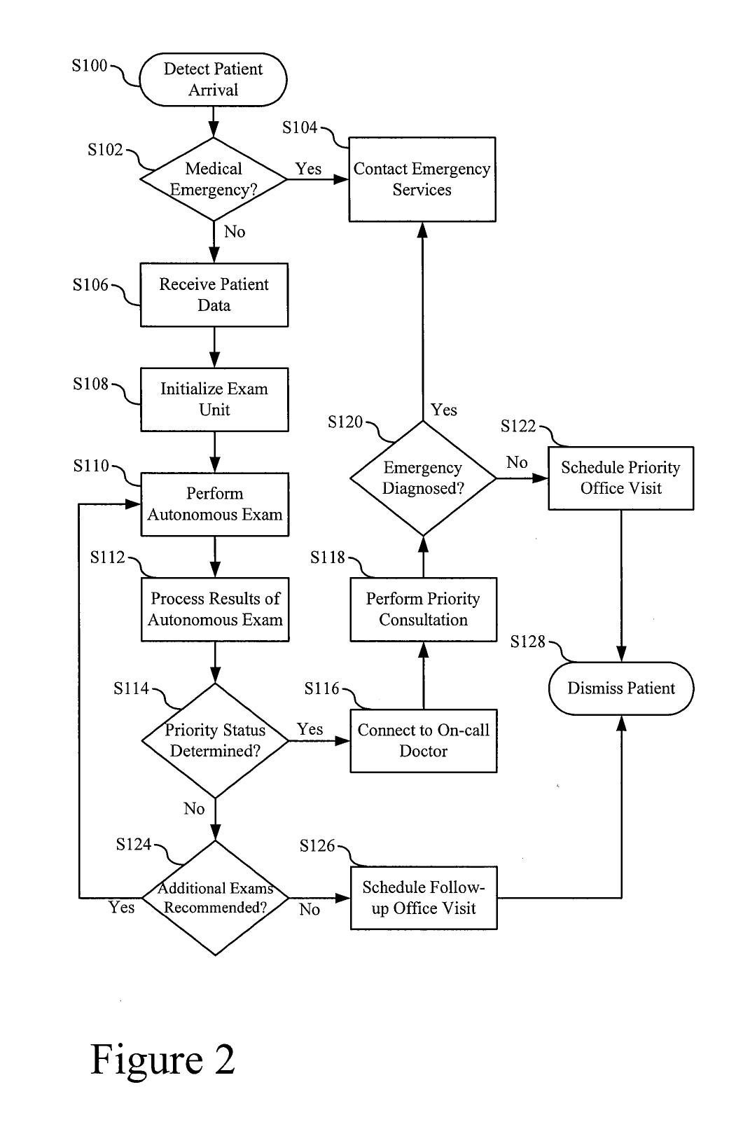

FIG. 2 is a sequence diagram of a patient examination using the automated dental exam and consultation system 1 according to an exemplary embodiment. Initially, the automated dental exam and consultation system 1 may be standing by at step S100 until a patient 102 arrival has been detected. If the patient 102 reports severe pain, excessive bleeding, or any other medical emergency at step S102, the system will contact emergency services 306 at step S104 for emergency assistance. If a medical emergency is not reported or indicated by the patient 102 at step S102, the patient reception unit 10 receives patient data, such as check in information and desired dental examinations, at step S106. Based on the received patient data at step S106, the patient reception unit 10 forwards the requested exams to the examination unit 20, which begins to initialize the corresponding examination equipment of the examining unit 20 at step S108. Once the patient 102 has been situated in the examination unit 20, the examination unit 20 performs an autonomous exam at step S110 based on the requested exams by the patient 102. After the exam has been completed, the examination unit 20 sends the results of the exam to the consulting unit 30 in order to process the exam results at step S112. Based on the processed exam results at step S112, the consulting unit 30 determines if a priority status has been detected at step S114. A priority status can be defined as any situation where the patient 102 has been detected to be in excessive pain, the results of the autonomous examination are unable to be processed, or the consulting unit 30 is unable to make a proper diagnosis. If the priority status has been determined at step S114, the consulting unit 30 attempts to connect to the on-call doctor at step 5116 and relays the results of the exam data to the on-call doctor 302. The on-call doctor 302 can interact with either the consulting unit 30 or directly with the patient 102 to perform a priority consultation at step S118. The consultation with the on-call doctor 302 can be over any appropriate form of communication such as video, audio, or textual communication. Based upon the results of the priority consultation at step S118, the on-call doctor 302 may assess that an emergency condition exists at step S120. If an emergency situation has been diagnosed by the on-call doctor 302 at step S120, the system contacts emergency services at step S104. If an emergency has not been detected at step S120, the on-call doctor 302 can schedule a priority office visit with the patient 102 at step S122. Once the priority office visit has been scheduled at step S122 the patient is dismissed at step S128. Returning to step S114, if a priority status has not been determined by the consulting unit 30, the consulting unit 30 can process the exam data and determine if additional exams are recommended at step S124. If additional exams are recommended at step S124, the exam unit 20 reinitializes any additional equipment required to perform the additional exams at step S110. If additional exams are not recommended at step S124, the consulting unit can coordinate with the patient reception unit 10 to schedule a follow-up office visit at step S126 if required. Once a follow-up office visit has been scheduled for the patient 102 at step S 126, the patient is dismissed at step S128.

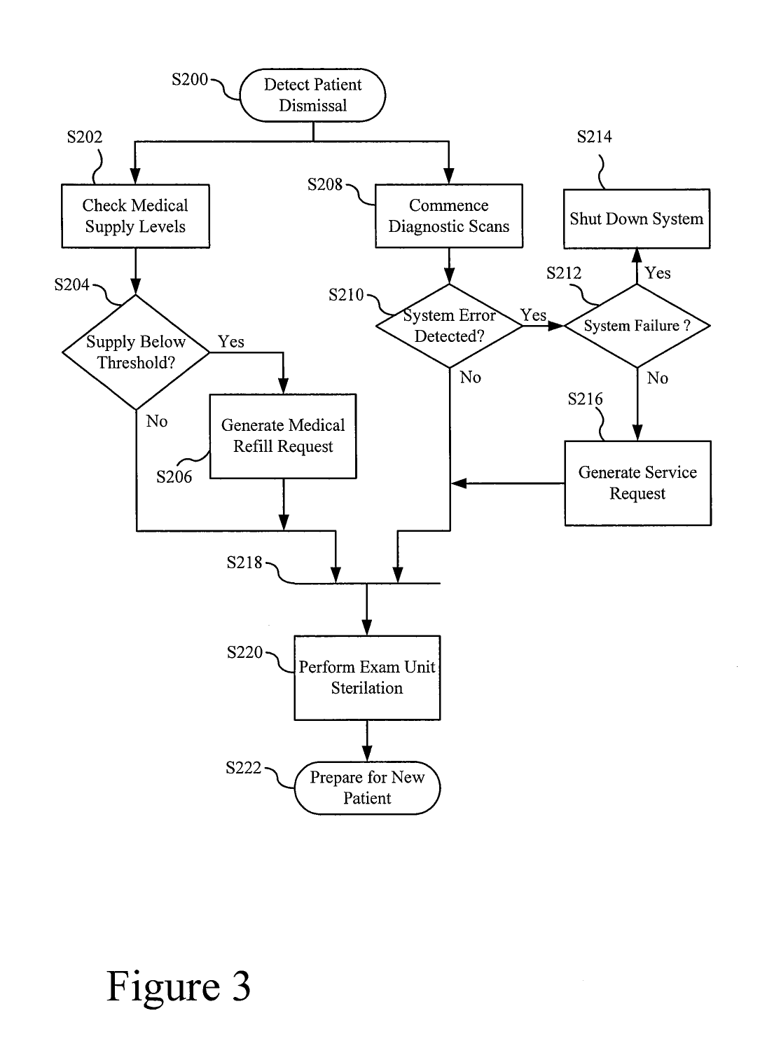

FIG. 3 is a sequence diagram of a maintenance cycle of the automated dental exam and consulting system 1 according to an exemplary embodiment. Maintenance cycles are typically performed between patient 102 visits or any time an issue or failure has been detected within the automated dental exam and consulting system 1. When it has been detected that a patient has been dismissed from the automated dental exam and consulting system 1 at step S200, the maintenance unit 40 performs, concurrently, a check of the medical supply levels of the examination unit 20 at step S202 as well as commences a diagnostic scan of various components within the system or of the system itself at step S208. When the maintenance unit 40 checks the medical supply levels at step S202, if any of the medical supplies are below a predetermined threshold at step S204, a request is sent to a maintenance technician 402 to refill medical supplies at step S206. If all of the medical supplies are above a predetermined threshold at step S204, the maintenance unit stands by at step S218 for the results of the diagnosis scan before performing additional functions. Concurrently with checking the medical supply levels of the examination unit 20, the maintenance unit 40 performs a series of diagnostic scans at step S208 of various components of the system or of the system itself If an error is detected within one of the system components during the diagnostic scan at step S210, a determination is made if the detected system error will result in a system failure at step S212. If it is determined that the detected system error will result in a system failure at step S212, the maintenance unit 40 will shut down automated dental exam and consulting system 1 at step S214 until the system failure is corrected by the maintenance technician 40. If the detected system error will not cause a system failure and the automated dental exam and consulting system 1 is capable of continued operation, a service request is generated at step 216 and is transmitted to the maintenance technician 402. Once the system diagnosis scan has been completed as well as the verification that all medical supplies are above a predetermined threshold at step S218, the maintenance unit 40 performs an exam unit sterilization at step S220 which includes all of the components used during the previous exam. Once the sterilization of the examination unit 20 has been complete at step S220, the automated dental exam and consultation system 1 reinitializes and prepares for a new patient at step S222.

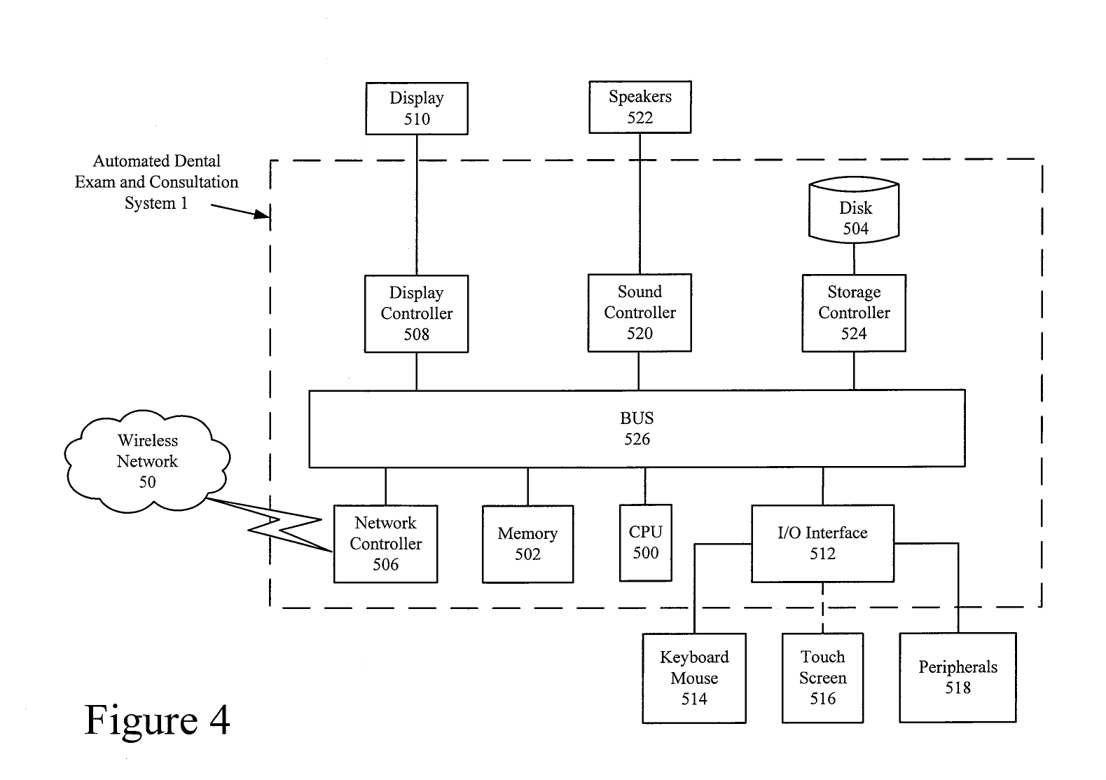

Next, a hardware description of the automated dental exam and consultation system 1 according to exemplary embodiments is described with reference to FIG. 4. In FIG. 4, the automated dental exam and consultation system 1 includes a CPU 500 which performs the processes described above. The process data and instructions may be stored in memory 502. These processes and instructions may also be stored on a storage medium disk 504 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the automated dental exam and consultation system 1 communicates, such as a server or computer.

Further, the claimed advancements may be provided as a utility application, background daemon, or component of an operating system, or combination thereof, executing in conjunction with CPU 500 and an operating system such as Microsoft Windows 7, UNIX, Solaris, LINUX, Apple MAC-OS and other systems known to those skilled in the art.

CPU 500 may be a Xenon or Core processor from Intel of America or an Opteron processor from AMD of America, or may be other processor types that would be recognized by one of ordinary skill in the art. Alternatively, the CPU 500 may be implemented on an FPGA, ASIC, PLD or using discrete logic circuits, as one of ordinary skill in the art would recognize Further, CPU 500 may be implemented as multiple processors cooperatively working in parallel to perform the instructions of the inventive processes described above.

The automated dental exam and consultation system 1 in FIG. 4 also includes a network controller 506, such as an Intel Ethernet PRO network interface card from Intel Corporation of America, for interfacing with network 50. As can be appreciated, the network 50 can be a public network, such as the Internet, or a private network such as an LAN or WAN network, or any combination thereof and can also include PSTN or ISDN sub-networks. The network 50 can also be wired, such as an Ethernet network, or can be wireless such as a cellular network including EDGE, 3G and 4G wireless cellular systems. The wireless network can also be WiFi, Bluetooth, or any other wireless form of communication that is known.

The automated dental exam and consultation system 1 further includes a display controller 508, such as a NVIDIA GeForce GTX or Quadro graphics adaptor from NVIDIA Corporation of America for interfacing with display 510, such as a Hewlett Packard HPL2445w LCD monitor. A general purpose I/O interface 512 interfaces with a keyboard and/or mouse 514 as well as a touch screen panel 516 on or separate from display 510. General purpose I/O interface also connects to a variety of peripherals 518 including printers and scanners, such as an OfficeJet or DeskJet from Hewlett Packard.

A sound controller 520 is also provided in the automated dental exam and consultation system 1, such as Sound Blaster X-Fi Titanium from Creative, to interface with speakers/microphone 522 thereby providing sounds and/or music. The speakers/microphone 522 can also be used to accept dictated words as commands for controlling the automated dental exam and consultation system 1 or for providing location and/or property information with respect to the target property.

The general purpose storage controller 524 connects the storage medium disk 504 with communication bus 526, which may be an ISA, EISA, VESA, PCI, or similar, for interconnecting all of the components of the automated dental exam and consultation system 1. A description of the general features and functionality of the display 510, keyboard and/or mouse 514, as well as the display controller 508, storage controller 524, network controller 506, sound controller 520, and general purpose I/O interface 512 is omitted herein for brevity as these features are known.

What is claimed is:

1. An automated dental exam and consultation system comprising:
a patient reception unit configured to receive patient information;
an examination unit that includes a plurality of medical supplies and configured to perform a desired dental examination, based on the patient information, on the patient;
a consulting unit configured to analyze the results of the desired dental examination, recommend another desired dental exam based on the analysis of the examination results, and store the desired dental examination results onto a dental exam database; and
a maintenance unit configured to perform a diagnostic analysis of the examination unit, generate a refill signal if one of the plurality of medical supplies falls below a predetermined threshold, generate a service request if a component of the examination unit needs repair, and sterilize the contents of examination unit.

2. The automated dental exam and consultation system of claim 1, wherein
the consulting unit determines an emergency situation, a priority situation, or a normal situation for the patient based on the result of the of the desired dental examination,
wherein the emergency situation is determined if the patient reports a life threatening condition and the consulting unit automatically contacts emergency services,
wherein the priority situation is determined if the patient reports a painful condition and the consulting unit automatically contacts an on-call doctor, and
wherein the normal condition is determined if the patient reports normal conditions and the consulting unit stores the results of the desired dental examination in a database.

3. A method of an automated dental exam and consultation system comprising the steps of:
receiving, using a patient reception unit, patient information from a patient;
performing, using a examination unit, a desired dental examination on the patient based on the received patient information and generate examination results;
analyzing, using a consulting unit, the examination results and recommending an additional desired dental examination based on the analysis; and
storing the examination results into a dental exam database;

4. The method of an automated dental exam and consultation system of claim 4, further comprising:
performing, using a maintenance unit, a diagnostic analysis of the examination unit that includes determining an amount a plurality of medical supplies and testing a plurality of operations of the examination unit;
generating a refill signal if the amount of one of the plurality of medical supplies falls below a predetermined threshold;
generating a repair signal if one of the plurality of operations of the examination unit is determined to be abnormal; and
performing a sterilization operation of the examination unit;

5. The method of an automated dental exam and consultation system of claim 5, further comprising:
securing operation of the automated dental exam and consultation system if one of the plurality of operations of the examination unit is determined to be abnormal.

6. The method of an automated dental exam and consultation system of claim 5, wherein
based on the results of the dental examination,
contacting emergency services if it is indicated that the patient is in a life threatening condition,
contacting an on-call doctor if it is indicated that the patient is in a painful condition, and
storing the results of the dental examination in a records database.

7. The method of an automated dental exam and consultation system of claim 7, wherein,
the recommending of an additional desired dental examination to the patient by the consulting unit is based on an expected condition of the patient based on the examination results from a plurality of previous patients.
